(19) United States
(12) Patent Application Publication
(10) Pub. No.: US 2025/0065235 A1
(43) Pub. Date: Feb. 27, 2025

(54) METHOD AND DEVICE FOR PROVIDING GAME SERVICE

(71) Applicant: NEXON KOREA CORPORATION, Seongnam-si (KR)

(72) Inventor: Jeongheon KIM, Seongnam-si (KR)

(21) Appl. No.: 18/811,316

(22) Filed: Aug. 21, 2024

(30) Foreign Application Priority Data
Aug. 24, 2023 (KR) 10-2023-0111508

(51) Int. Cl. A63F 13/85

(52) U.S. Cl. CPC A63F 13/85

(57) ABSTRACT

A method, performed by a game-providing device, of providing a game service is disclosed. The method includes obtaining enhancement information indicating information associated with enhancement of an equipment item that is to be enhanced from among items in a game. The method includes identifying a first input for enhancing the equipment item. The method includes generating, based on the enhancement information and the first input, a first auxiliary item for enhancing the equipment item by reflecting a result of enhancing the equipment item.

### CROSS-REFERENCE TO RELATED APPLICATION

This application is based on and claims priority under 35 U.S.C. § 119 to Korean Patent Application No. 10-2023-0111508, filed on Aug. 24, 2023, in the Korean Intellectual Property Office, the disclosure of which is incorporated by reference herein in its entirety.

### BACKGROUND

### Technical Field

The disclosure relates to a method and device for providing a game service. More specifically, the disclosure relates to a method and device for providing a game service that diversifies methods of performing enhancement with respect to equipment items.

### Description of the Related Art

Recently, many games of various genres have been developed, leading to an explosive increase in the number of users. As games of various genres have been developed and the performance of devices for playing such games has improved, gaming has emerged as a mainstream hobby.

In the gaming industry, various systems can be introduced to encourage user participation in a game, and encourage users' interest in the game by allowing them to try new strategies while playing the game. For example, by introducing a system where a game can be played using enhanced characters, abilities, or items, a user's desire to collect or upgrade items associated with enhancement is promoted, and thus, the user's fun and interest in the game may be increased.

### BRIEF SUMMARY

An embodiment of the disclosure include a method and device for providing a game service that diversifies methods of performing enhancement with respect to an equipment item.

Additional aspects will be set forth in part in the description which follows and, in part, will be apparent from the description, or may be learned by practice of the presented embodiments of the disclosure.

According to an embodiment, a method, performed by a game-providing device, of providing a game service includes obtaining enhancement information indicating information associated with enhancement of an equipment item that is to be enhanced from among items in a game, identifying a first input for enhancing the equipment item, and generating, based on the enhancement information and the first input, a first auxiliary item for enhancing the equipment item, by reflecting a result of enhancing the equipment item.

According to an embodiment, a game-providing device includes a memory storing instructions, and at least one processor functionally connected to the memory and configured to execute the instructions, wherein the at least one processor is configured to execute the instructions to obtain enhancement information indicating information associated with enhancement of the equipment item that is to be enhanced from among items in a game, identify a first input for enhancing the equipment item; and generate, based on the enhancement information and the first input, a first auxiliary item for enhancing the equipment item, by reflecting a result of enhancing the equipment item.

According to an embodiment, a server includes a memory storing instructions, and at least one processor functionally connected to the memory and configured to execute the instructions, wherein the at least one processor is configured to execute the instructions to obtain enhancement information indicating information associated with enhancement of the equipment item that is to be enhanced from among items in a game, identify a first input for enhancing the equipment item; and generate, based on the enhancement information and the first input, a first auxiliary item for enhancing the equipment item, by reflecting a result of enhancing the equipment item.

According to an embodiment, a user terminal for providing a game service includes a user interface configured to receive a user input, a memory storing instructions, and at least one processor functionally connected to the user interface and the memory and configured to execute the instructions, wherein the at least one processor is configured to execute the instructions to obtain enhancement information indicating information associated with enhancement of the equipment item that is to be enhanced from among items in a game, identify a first input for enhancing the equipment item, and generate, based on the enhancement information and the first input, a first auxiliary item for enhancing the equipment item, by reflecting a result of enhancing the equipment item.

According to an embodiment, a computer-readable recording medium has recorded thereon a program, which, when executed by a computer, performs a method of providing a game service, the method including obtaining enhancement information indicating information associated with enhancement of an equipment item that is to be enhanced from among items in a game, identifying a first input for enhancing the equipment item, and generating, based on the enhancement information and the first input, a first auxiliary item for definitively enhancing the equipment item, by reflecting a result of enhancing the equipment item.

### BRIEF DESCRIPTION OF THE SEVERAL VIEWS OF THE DRAWINGS

The above and other aspects, features, and advantages of certain embodiments of the inventive concept will be more apparent from the following description taken in conjunction with the accompanying drawings, in which:

FIG. 1 illustrates a game-providing system including a server and a user terminal, according to various embodiments;

FIG. 2 is a conceptual diagram for explaining an operation of generating a first auxiliary item, according to an embodiment;

FIG. 3 is a conceptual diagram for explaining an operation of enhancing an equipment item by applying a first auxiliary item to the equipment item, according to an embodiment;

FIG. 4 is a flowchart of a method of providing a game service, according to an embodiment;

FIG. 5 is a conceptual diagram for explaining an operation of generating a second auxiliary item, according to an embodiment;

FIG. 6 is a view for explaining an operation of performing an enhancement according to whether an equipment item is possessed, according to an embodiment;

FIG. 7 is a view for explaining an operation of performing an enhancement according to whether an equipment item is possessed, according to an embodiment;

FIG. 8 is a view for explaining an operation of performing an enhancement according to whether an equipment item is possessed, according to an embodiment;

FIG. 9 is a view for explaining an operation of performing an enhancement according to whether an equipment item is possessed, according to an embodiment;

FIG. 10 is a view for explaining a method of setting a validity period for an auxiliary item, according to an embodiment;

FIGS. 11A through 11C are diagrams for explaining user interfaces for generating a first auxiliary item, according to an embodiment;

FIG. 12 is a diagram for explaining an operation of setting a default value associated with enhancement, according to an embodiment;

FIG. 13 is a diagram for explaining a user interface for purchasing or selling an auxiliary item, according to an embodiment;

FIG. 14 is a block diagram of a detailed configuration of a game-providing device according to an embodiment;

FIG. 15 is a block diagram of a detailed configuration of a server according to an embodiment; and

FIG. 16 is a block diagram of a detailed configuration of a user terminal according to an embodiment.

### DETAILED DESCRIPTION

Reference will now be made in detail to embodiments, examples of which are illustrated in the accompanying drawings. A method of constructing and using an electronic device, according to an embodiment of the present disclosure, will now also be described with reference to the accompanying drawings. Like reference numerals or characters in the drawings denote like parts or components.

Throughout the disclosure, the expression “at least one of a, b or c” indicates only a, only b, only c, both a and b, both a and c, both b and c, all of a, b, and c, or variations thereof.

While such terms as “first”, “second”, etc., may be used to describe various components, such components must not be limited to the above terms. The terms first and second should not be used to attach any order of importance but are used to distinguish one element from another element. For example, a first component discussed below could be termed a second component, and similarly, a second component may be termed a first component without departing from the teachings of the present disclosure. The term “and/or” includes any and all combinations of one or more of the associated listed items.

The terms used in the present specification are merely used to describe particular embodiments, and are not intended to limit the inventive concept. An expression used in the singular encompasses the expression of the plural, unless it has a clearly different meaning in the context. In the present specification, it is to be understood that the terms such as “including”, “having”, and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Throughout the specification, when an element is referred to as being “connected” or “coupled” to another element, it can be directly connected or coupled to the other element, or can be electrically connected or coupled to the other element with intervening elements interposed therebetween. The terms “comprises”, “comprising”, “includes” and “including” when used in this specification, specify the presence of stated elements, but do not preclude the presence or addition of one or more other elements. The terms “unit”, “-er (-or)”, and “module” when used in this specification refers to a unit in which at least one function or operation is performed, and may be implemented as hardware, software, or a combination of hardware and software.

To be more specific, the term “unit” may include any electrical circuitry, features, components, an assembly of electronic components or the like. That is, “unit” may include any processor-based or microprocessor-based system including systems using microcontrollers, integrated circuit, chip, microchip, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit.”

In some embodiments, the various units described herein may be included in or otherwise implemented by processing circuitry such as a microprocessor, microcontroller, or the like.

In the disclosure below, a game-providing device may be a game server, a user terminal, a game system including a game server and a user terminal, or an independent device.

In the disclosure below, a server controlling a user terminal may refer to the server providing outputs of a user terminal (all output of the user terminal, such as a screen display, a sound output, a vibration output, and lamp emission) and the data to perform a certain operation by user terminal through communication with the user terminal. Of course, the user terminal may control an output of the user terminal by using pre-stored data. Embodiments are not limited to the above example.

In the disclosure below, transmitting and receiving information or data to and from a user (or a user account) may include the meaning of transmitting and receiving information or data to and from a device (or a user terminal) corresponding to or linked to the user (or the user account).

In the disclosure below, a user, a player, a user, a user account, and a gamer may be understood as having the same meaning as each other. In the disclosure, it should be understood that the user terminal may indicate a user, a player, a user account, or a gamer, or may indicate a device used by them, depending on the context. In the disclosure, it should be understood that a user, a player, a user account, or a gamer may indicate, an avatar or character manipulated by them or may indicate a device used by them, depending on the context.

In the disclosure below, an ‘item’ may include all objects, goods, content, etc., and may refer to, but is not limited to, equipment worn by in-game characters (such as, weapons, armor, accessories, clothes, and crystals), vehicles ridden by in-game characters, consumables (such as, food and potions), all digital content obtainable by a user within the game (such as, experience points and buffs), and cyber objects.

In the disclosure below, an ‘equipment item’ may include items such as weapons, armor, accessories, clothes, and crystals that in-game characters can equip, possess, or wear to improve in-game abilities, but embodiments are not limited thereto.

In the disclosure below, an ‘auxiliary item’ is an item in which a result of enhancing an equipment item has been reflected, and may include an item used auxiliarily to change the performance of the equipment item.

In the disclosure below, ‘enhancement’ may include an action to change the performance of an item to be enhanced. Changing the performance of the item to be enhanced may include an improvement in a quantified ability parameter of the item to be enhanced or an attempt to improve the quantified ability parameter of the item to be enhanced, and may include all actions that change the quantified parameter for the item to be enhanced. A method of performing enhancement is not limited to the above examples, and may include direct or indirect means for the item that is to be enhanced.

Enhancing an equipment item by applying or utilizing an auxiliary item (including a first auxiliary item and a second auxiliary item) to the equipment item may be ensuring an enhancement of the equipment item. Directly performing enhancement on an equipment item or performing enhancement to generate an auxiliary item may be not guaranteeing enhancement of the equipment item.

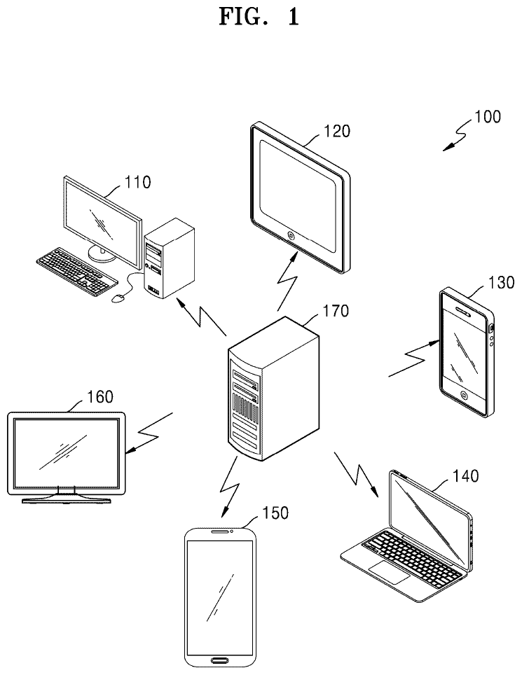

FIG. 1 illustrates a game-providing system including a server and a user terminal, according to various embodiments.

A game-providing system 100 according to the disclosure may include a server 170 and one or more user terminals 110 through 160. The server 170 may provide various online activities to the one or more user terminals 110 through 160 through a network. The server 170 may simultaneously provide an online activity to the one or more user terminals 110 through 160.

According to an embodiment, the server 170 may include, but is not limited to, a single server, a collection of servers, a cloud server, etc. The server 170 may provide various online activities to the one or more user terminals 110 through 160, and may include a database that stores data for an online activity of the one or more user terminals 110 through 160. The server 170 may also include a payment server that generates and processes payment events. As described above, the server 170 may be a game-providing device.

According to an embodiment, a network refers to a connection established (or formed) using all communication methods, and may refer to a communication network connected through all communication methods of transmitting and receiving data between terminals and between a terminal and a server.

The communication methods may include communication via a selected communication standard, a selected frequency band, a selected protocol, or a selected channel. For example, the communication methods may include communication methods via Bluetooth, BLE, Wi-Fi, Zigbee, 3G, LTE, and ultrasound waves, and may include all of short-range communication, long-range communication, wireless communication, and wired communication. Embodiments are not limited thereto.

According to an embodiment, the short-range communication method may refer to a communication method that allows communication only when a device (terminal or server) performing communication is within a selected range, and, for example, may include Bluetooth, NFC, etc. The long-range communication method may refer to a communication method in which a device performing communication is able to communicate regardless of a distance. For example, the long-range communication method may refer to a method enabling communication even when two devices that perform communication through a repeater such as an AP is equal to or greater than a selected distance, and may include a communication method using a cellular network (3G or LTE) such as a short message service (SMS) or a telephone. Embodiments are not limited thereto. Receiving online activities by using a network may include a meaning that communication between a server and a terminal can be performed through any communication method.

Throughout the specification, the one or more user terminals 110 through 160 may include, but are not limited to, various electronic devices, such as not only a personal computer 110, a tablet 120, a cellular phone 130, a laptop 140, a smartphone 150, and a TV 160, but also personal digital assistants (PDAs), a portable multimedia player (PMP), a navigation device, an MP3 player, a digital camera, a refrigerator, a washing machine, and a vacuum cleaner. As described above, the one or more user terminals 110 through 160 may be game-providing devices.

According to an embodiment, online activities may include, but are not limited to, an online game, a portal service, and a social network service (SNS). Examples of the online game may include a variety of genres, including sports, MMORPG, AOS, FPS, TCG, and CCG. The online game may be a game that pit users against each other, or between a user and a computer (for example, artificial intelligence). Of course, the online game is not limited to the above examples, and there are no restrictions on the form of online games.

A game-providing device according to an embodiment may perform enhancement with respect to an equipment item independently of whether the equipment item is possessed. The game-providing device may generate an auxiliary item by reflecting a result of enhancing the equipment item independently of whether or not the equipment item is possessed through an in-game enhancement system, and may provide a game service that enhances the equipment item by using the generated auxiliary item.

According to an embodiment, the game-providing system 100 may obtain enhancement information indicating information related to the enhancement of the equipment item that is to be enhanced among in-game items. The game-providing system 100 may identify a first input for enhancing the equipment item. The game-providing system 100 may reflect the result of enhancing the equipment item, based on the enhancement information and the first input, to generate the auxiliary item that enhances the equipment item, and the generated auxiliary item may be referred to as a first auxiliary item.

According to an embodiment, the auxiliary item may include a first auxiliary item and a second auxiliary item, and the first auxiliary item and the second auxiliary item are only described using ordinal numbers in order to distinguish them from each other, and are not limited by the term.

According to an embodiment, the server 170 may obtain enhancement information indicating information related to the enhancement of the equipment item that is to be enhanced among in-game items. The server 170 may identify a first input for enhancing the equipment item. The server 170 may reflect the result of enhancing the equipment item, based on the enhancement information and the first input, to generate the auxiliary item that enhances the equipment item, and the generated auxiliary item may be referred to as a first auxiliary item.

According to an embodiment, one of the one or more user terminals 110 through 160 may obtain enhancement information indicating information related to the enhancement of the equipment item that is to be enhanced among in-game items. One of the one or more user terminals 110 through 160 may identify the first input for enhancing the equipment item. One of the one or more user terminals 110 through 160 may reflect the result of enhancing the equipment item, based on the enhancement information and the first input, to generate the auxiliary item that enhances the equipment item, and the generated auxiliary item may be referred to as a first auxiliary item.

In an embodiment, some or all of the operations of the server 170 may be performed in the user terminals 110 through 160. For example, a method of providing a game service, according to an embodiment, may be performed by the user terminals 110 through 160 without communication with the server 170.

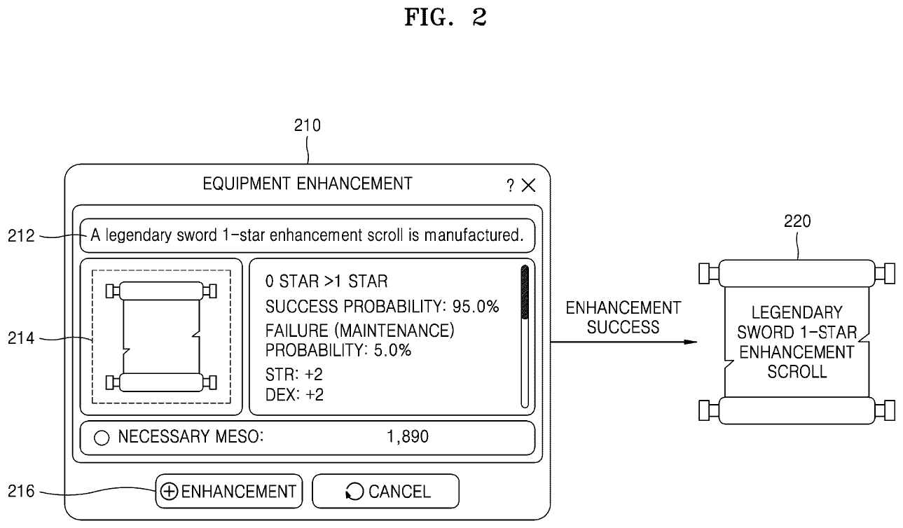

FIG. 2 is a conceptual diagram for explaining an operation of generating the first auxiliary item, according to an embodiment.

Referring to FIG. 2, according to an embodiment, a game-providing device may perform enhancement with respect to an equipment item independently of whether a user possesses the equipment item. For example, the game-providing device may perform enhancement with respect to the equipment item even when the user does not possess the equipment item. The game-providing device may perform enhancement with respect to the equipment item even when the user possesses the equipment item. The ‘enhancement with respect to the equipment item’ may include both direct and indirect means of the enhancement of the equipment item.

In an embodiment, the game-providing device may generate an auxiliary item that enhances an equipment item, using a manner similar to a method of directly performing enhancement on the equipment item. The auxiliary item that enhances the equipment item may be the first auxiliary item.

For example, the game-providing device may perform stochastic enhancement with a success probability of 95.0% and a failure probability of 5.0% with respect to the equipment item. In the method of directly performing enhancement on the equipment item, when the game-providing device directly performs enhancement on the equipment item and succeeds in the enhancement with a 95.0% probability, and then an effect corresponding to a success in the enhancement may be imparted to the equipment item within a selected time period after the enhancement is performed. When the game-providing device directly performs enhancement on the equipment item and fails in the enhancement with a 5.0% probability, an effect corresponding to the failure of the enhancement may be given to the equipment item or the user.

In an embodiment, the game-providing device may reflect the result of enhancing the equipment item in the first auxiliary item in a manner similar to the method of directly performing enhancement, and the game-providing device may ensure the enhancement of the equipment item passing on the result of performing enhancement to the equipment item by applying the first auxiliary item to the equipment item.

For example, when the game-providing device performs an enhancement with a success probability of 95.0% with respect to the equipment item and succeeds in the enhancement, the game-providing device may generate the first auxiliary item. The generated first auxiliary item may include information about the effect corresponding to a success of the enhancement with respect to the equipment item. For example, the effect corresponding to the success in the enhancement may be an improvement in the quantified attribute parameters for the equipment item. When the game-providing device generates the first auxiliary item, the game-providing device may include information that improves the quantified attribute parameter for the equipment item as an attribute of the first auxiliary.

When applying the generated first auxiliary item to the equipment item that is to be enhanced, the game-providing device may give the equipment item an effect corresponding to successful enhancement within a selected time period. When the game-providing device performs enhancement with a success probability of 95.0% with respect to the equipment item and fails in the enhancement, an effect corresponding to a failure of the enhancement with respect to the equipment item may be given to the equipment item or the user, or a penalty may be given to an auxiliary item that is to be generated as the equipment item is subsequently enhanced.

In an embodiment, the game-providing device may obtain enhancement information indicating information associated with the enhancement of the equipment item that is to be enhanced from among in-game items, and the game-providing device may provide a user interface 210 (hereinafter, referred to as an enhancement interface) including the obtained enhancement information. However, not all of the components shown in FIG. 2 are essential, and an enhancement interface may be displayed by more components than those shown in FIG. 2. For example, when there is a limit to the number of enhancements, the enhancement interface 210 may include the total limited number of enhancements and the number of remaining enhancements. The enhancement interface 210 may include, but is not limited to, other configurations for changing the quantified ability parameter, wearing level restrictions, and enhancement probability of the equipment item that is to be enhanced.

In an embodiment, the enhancement interface 210 may include at least one of a name 212 of the equipment item to be enhanced, a shape 214 of an auxiliary item to be generated by reflecting a result of enhancing the equipment item, an enhancement success probability, an enhancement failure probability, goods required to perform enhancement, and an effect corresponding to a success of the enhancement. The enhancement interface 210 may include an enhancement banner 216 for obtaining a user's input for enhancing the equipment item. For example, the name 212 of the equipment item to be enhanced may be a ‘Legendary Sword’. The auxiliary item to be generated by reflecting the result of enhancing the equipment item may be a ‘Legendary Sword 1-Star Enhancement Scroll’.

According to an embodiment, the enhancement banner 216 may be a banner including a word ‘enhancement’. The game-providing device may identify a user input for enhancing the equipment item. For example, the game-providing device may obtain a user input for enhancing the ‘Legendary Sword’ from the user through a touch input for an enhancement banner displayed on the display. A user input for enhancing the equipment item may be referred to as a first input to be distinguished from a user input that is obtained later, and is only described including an ordinal number for the purpose of being distinguished from other user inputs, and is not limited by the term. The user input may be, but is not limited to, at least one of a touch input, a voice input, a keyboard input, and a sensor data input.

According to an embodiment, the game-providing device may perform or try enhancement with respect to an equipment item, based on identification of the first input. The game-providing device may generate a first auxiliary item 220, based on a successful enhancement with respect to the equipment item. When the game-providing device fails to enhance the equipment item, the game-providing device may deduct the goods needed to perform the enhancement and may not generate the first auxiliary item 220. For example, when the game-providing device successfully enhances the ‘Legendary Sword’, the game-providing device may deduct Meso 1,890, which is a type of game money, as enhancement costs, which are the goods needed to perform the enhancement, and may generate the first auxiliary item 220 called a ‘Legendary Sword 1-Star Enhancement Scroll’. When the game-providing device fails to enhance the equipment item, the game-providing device may deduct Meso 1,890, which is a type of game money, and may not generate the ‘Legendary Sword 1-Star Enhancement Coupon’. Effects corresponding to a case where the enhancement with respect to the equipment item has been successfully performed and a case where the enhancement with respect to the equipment item has failed are not limited to the disclosed examples. The enhancement costs do not have to be fixed, and may fluctuate.

Although it has been illustrated and described that the probability of generating the first auxiliary item and the probability of success by directly enhancing the equipment item are the same as each other, embodiments are not limited thereto. The probability of generating the first auxiliary item may represent the probability that an enhancement with respect to the equipment item is successfully performed and thus the first auxiliary item is generated.

In an embodiment, the probability of generating the first auxiliary item may be different from the probability that a direct enhancement of the equipment item is successfully performed. For example, the probability of generating the first auxiliary item may be greater or less than the probability that a direct enhancement of the equipment item is successfully performed.

In an embodiment, considering a penalty that may occur when the equipment item is directly enhanced, the probability of generating the first auxiliary item may be less than the probability that a direct enhancement of the equipment item is successfully performed. For example, when the probability that a direct enhancement with respect to the equipment item to be enhanced is successfully performed is 50.0%, and there is a penalty of destroying equipment when the enhancement fails, the probability that the first auxiliary item is generated may be 10.0%.

In an embodiment, the probability of generating the first auxiliary item may be greater than the probability that a direct enhancement of the equipment item is successfully performed. For example, when the probability that a direct enhancement with respect to the equipment item to be enhanced is successfully performed may be 40.0%, and the probability that the first auxiliary item is generated may be 50.0%.

For convenience of explanation, an equipment item ‘Legendary Sword’ will now be illustrated and described, but embodiments are not limited thereto. Although a ‘stochastic enhancement’ has been illustrated and described, the type of enhancement is not limited thereto.

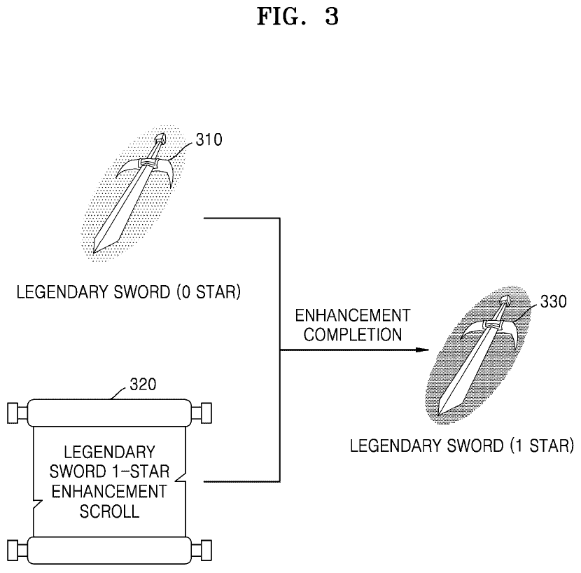

FIG. 3 is a conceptual diagram for explaining an operation of enhancing an equipment item by applying a first auxiliary item to the equipment item, according to an embodiment.

In an embodiment, the game-providing device may identify whether a user possesses an equipment item 310 that is to be enhanced and a first auxiliary item 320, which is an auxiliary item in which a result of enhancing the equipment item 310 has been reflected. For example, the game-providing device may identify whether the user has the equipment item 310 and the first auxiliary item 320 in his or her item inventory. An operation, performed by the game-providing device, of enhancing the equipment item 310 by applying the first auxiliary item 320 to the equipment item 310 when the game-providing device identifies that the item inventory includes the equipment item 310 and the first auxiliary item 320 will now be described in detail.

In an embodiment, the game-providing device may obtain an equipment item 330 enhanced by obtaining or identifying a drag input or touch input using a mouse or touch screen from the user. The drag input may be an input of moving the first auxiliary item to an equipment item while clicking on the first auxiliary item by using a mouse or touch screen, and the touch input may be an input of touching the first auxiliary item one or more times by using the mouse or touch screen.

The user input that the game-providing device identifies to obtain the enhanced equipment item 330 is not limited to the disclosed example.

In an embodiment, the game-providing device may obtain, from the user, a drag input of dragging a legendary sword 1-star enhancement scroll, which is the first auxiliary item 320, to a ‘legendary sword’, which is the equipment item 310. The game-providing device may guarantee the obtainment of a ‘1-star legendary sword’, which is an enhanced equipment item 310, based on the obtained drag input.

In an embodiment, the first auxiliary item may include information associated with at least one type and at least one enhancement for the equipment item. The information associated with enhancement included in the first auxiliary item may include information associated with level-by-level enhancement for level improvement by two or more levels. For example, the first auxiliary item may be a ‘Legendary Sword 2-Star Enhancement Scroll’. In this case, the first auxiliary item may be applied to a 0-star or 1-star legendary sword, and a ‘2-star legendary sword’ may be obtained using the first auxiliary item.

Although the equipment item ‘Legendary Sword’ has been illustrated and described, embodiments are not limited thereto, and an ‘N-star (where N is an integer equal to or greater than 0)’ added before or after the name of an item may indicate the number of enhancements for a given level of enhancement.

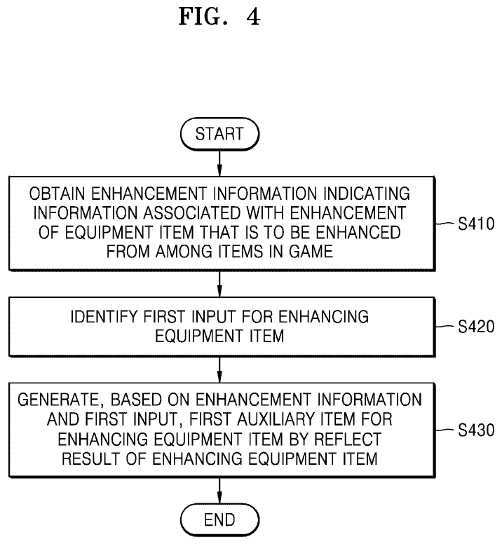

FIG. 4 is a flowchart of a method of providing a game service, according to an embodiment.

Referring to FIG. 4, in operation S410, the game-providing device may obtain enhancement information indicating information associated with enhancement of an equipment item that is to be enhanced from among items in a game.

According to an embodiment, the game-providing device may identify the equipment item that is to be enhanced among in-game items, and may obtain the enhancement information indicating the information related to the enhancement of the equipment item that is to be enhanced.

In an embodiment, the enhancement information may include at least one of the equipment item that is to be enhanced, the quantified ability parameter of the equipment item that is to be enhanced, the total number of enhancement limits, the number of remaining enhancements, the type of enhancement that may be performed on the equipment item, goods required to perform enhancement, an enhancement success probability, an enhancement failure probability, an effect corresponding to a success of enhancement, and an effect corresponding to a failure of enhancement.

In an embodiment, the game-providing device may provide a user with an enhancement interface based on the obtained enhancement information, and the enhancement interface may include a configuration for obtaining a user input for enhancing an equipment item. The enhancement interface may include the configuration for obtaining the user input for enhancing the equipment item, regardless of whether the user possesses the equipment item.

The enhancement interface may be provided using a display or voice, and embodiments are not limited thereto.

In operation S420, the game-providing device may identify a first input for enhancing the equipment item.

In an embodiment, the game-providing device may obtain the user input for enhancing the equipment item, and the user input for enhancing the equipment item may be referred to as a first input. For example, the game-providing device may obtain the user input for enhancing the equipment item, in correspondence with provision of the enhancement interface.

In an embodiment, the first input for enhancing the equipment item may not be an input for directly enhancing the equipment item, but may be an input for generating an auxiliary item that ensures enhancement of the equipment item.

The first input may be, but is not limited to, at least one of a touch input, a voice input, a keyboard input, and a sensor data input that are obtained from the user.

In operation S430, the game-providing device may generate the first auxiliary item for enhancing the equipment item by reflecting a result of enhancing the equipment item based on the enhancement information and the first input.

In an embodiment, the game-providing device may perform enhancement on the equipment item, based on the first input, and may generate the first auxiliary item, based on the enhancement information. As the first input is identified from the user, the game-providing device may perform enhancement with respect to the equipment item independently of whether the user possesses the equipment item.

In an embodiment, the game-providing device may try enhancement of the equipment item, based on the enhancement success probability included in the enhancement information, and the game-providing device may generate the first auxiliary item, based on successful execution of the enhancement. When the enhancement has been successful executed, the game-providing device may include, in the first auxiliary item, an effect that is directly given to the equipment item as an attribute of a first auxiliary item. For example, the first auxiliary item may include information on at least one of the type of enhancement performed, the amount of change in the quantified ability parameter of the equipment item, a validity period, and the number of remaining enhancements.

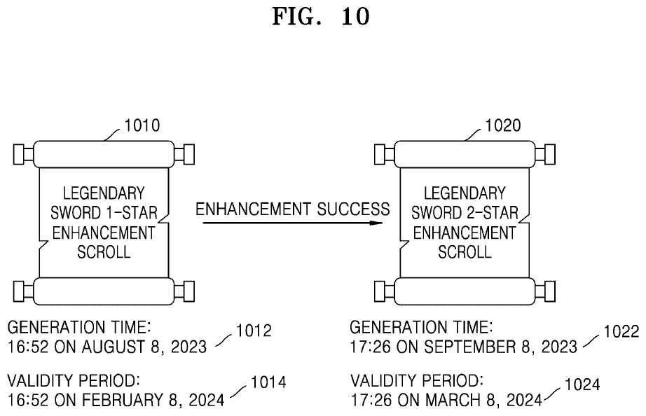

In an embodiment, the game-providing device may obtain an effect corresponding to an enhancement failure, based on the enhancement being failed. The effect corresponding to an enhancement failure may include, but is not limited to, deduction of the goods required to perform enhancement, or deduction of the number of remaining enhancements when enhancement is performed later. The validity period of the auxiliary item will be explained in detail with reference to FIG. 10.

In an embodiment, the first auxiliary item may include information about the number of remaining enhancements that is subtracted by the number of times enhancement has been performed. The first auxiliary item may include other effects that correspond to the success of enhancement, without being limited to the disclosed example.

In an embodiment, the enhancement cost, which is goods needed to perform enhancement, may be a value that changes based on the user's demand. The user's action for generating an auxiliary item may be considered as a factor for determining the enhancement cost. For example, when the enhancement cost is determined considering the number of attempts to generate the auxiliary item, the enhancement cost of the equipment item may be prevented from falling excessively compared to an in-game value even when the equipment item that is to be enhanced is insufficient. Additionally, when the enhancement cost of the equipment item becomes stable, the market price of the equipment item may also be stabilized as a result.

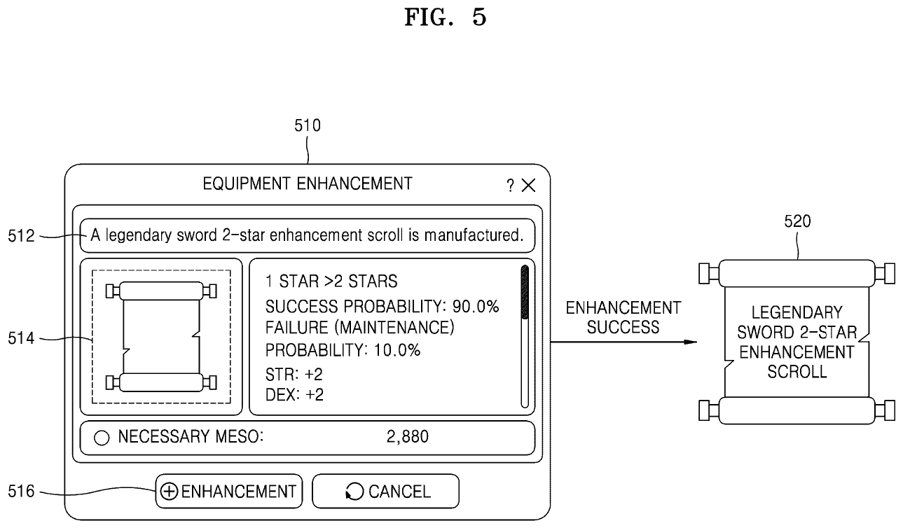

An operation, performed by the game-providing device, of generating a second auxiliary item that enhances the equipment item by reflecting a result of enhancing the first auxiliary item, after performing an operation of generating the first auxiliary item, will be described below with reference to FIG. 5.

FIG. 5 is a conceptual diagram for explaining an operation of generating a second auxiliary item, according to an embodiment.

In an embodiment, the game-providing device may perform a plurality of enhancements with respect to an equipment item that is to be enhanced. The game-providing device may generate an auxiliary item in which a result of enhancing the equipment item has been reflected by perform multiple enhancements on an auxiliary item generated in response to the multiple enhancements on the equipment item. The auxiliary item generated in response to the multiple enhancements may be referred to as a second auxiliary item.

In an embodiment, an initial enhancement with respect to the equipment item may be referred to as a first enhancement with respect to the equipment item. Accordingly, the first enhancement with respect to the equipment item may correspond to generation of the first auxiliary item. The game-providing device additionally enhancing the equipment item may be referred to as a second enhancement with respect to the equipment item. Accordingly, the second enhancement with respect to the equipment item may correspond to generation of the second auxiliary item.

The second enhancement does not have to be the same type of enhancement as the first enhancement, and the effect of the second enhancement may be the same as or different from the effect of the first enhancement. Although the term “multiple enhancements” is used to explain that enhancement may be performed on the first auxiliary item, the first auxiliary item or the second auxiliary item of the disclosure may be an auxiliary item generated by multiple enhancements or multiple types of enhancements.

In an embodiment, the game-providing device may obtain or identify a user input for enhancing the first auxiliary item in order to additionally enhance the equipment item. A user input for enhancing the first auxiliary item may be referred to as a second input to be distinguished from the first input. The second input may be at least one of a touch input, a voice input, a keyboard input, and a sensor data input that are obtained from the user, but is not limited to.

In an embodiment, the game-providing device may generate, based on the enhancement information and the second input, a second auxiliary item 520 that enhances the equipment item by reflecting a result of enhancing the first auxiliary item. As the second input is identified from the user, the game-providing device may perform enhancement with respect to the equipment item independently of whether the user possesses the equipment item. The game-providing device may perform enhancement on the first auxiliary item, based on the second input, and may generate the second auxiliary item 520, based on a successful enhancement with respect to the first auxiliary item. The second auxiliary item 520 may include information about an effect corresponding to a success of the first enhancement and the second enhancement.

In an embodiment, the game-providing device may perform or try enhancement with respect to the first auxiliary item, based on an enhancement success probability of the second enhancement with respect to the equipment item included in the enhancement information, and the game-providing device may generate the second auxiliary item 520, based on successful execution of the enhancement. For example, when the enhancement success probability of the second enhancement with respect to the equipment item is 90.0%, the enhancement success probability of the enhancement with respect to the first auxiliary item may be 90.0%.

In an embodiment, the game-providing device may obtain an effect corresponding to a failure in the second enhancement with respect to the equipment item, based on the enhancement with respect to the first auxiliary item being failed. For example, the effect corresponding to a failure in the second enhancement with respect to the equipment item may include, but is not limited to, at least one of subtraction of the number of remaining enhancements included in the first auxiliary item, subtraction of the goods possessed, reduction of the amount of change in the quantified ability parameter included in the first auxiliary item, and maintenance of an effect on the first auxiliary item.

In an embodiment, the game-providing device may obtain a user interface 510 (hereinafter, referred to as an enhancement interface) including the obtained enhancement information. The enhancement information may include information associated with the second enhancement of the equipment item. Because the information associated with the second enhancement corresponds to the enhancement information associated with the enhancement of the equipment item of FIG. 2, duplicate matters are omitted.

In an embodiment, the game-providing device may include, through the enhancement interface 510, at least one of a name 512 of the equipment item to be enhanced, a shape 514 of an auxiliary item to be generated by reflecting a result of enhancing the equipment item, and an enhancement banner 516 for obtaining a user input for enhancing the first auxiliary item. For example, the name 512 of the equipment item may be a ‘Legendary Sword’. The first auxiliary item may be a ‘Legendary Sword 1-Star Enhancement Scroll’. The enhancement banner 516 may be a banner including a word ‘enhancement’.

In an embodiment, the game-providing device may identify or obtain a user input for an enhancement banner as the second input for enhancing the first auxiliary item. The game-providing device may perform or try enhancement with respect to the ‘Legendary Sword 1-Star Enhancement Scroll’, based on identification of a touch input for the enhancement banner. When the game-providing device successfully enhances the ‘Legendary Sword 1-Star Enhancement Scroll’, the game-providing device may obtain a ‘Legendary Sword 2-star Enhancement Ticket’ as the second auxiliary item 520. When the game-providing device fails to enhance the ‘Legendary Sword 1-Star Enhancement Scroll’, he game-providing device may change some of the properties of the ‘Legendary Sword 1-Star Enhancement Scroll’ or keep the properties unchanged, and may also destroy the ‘Legendary Sword 1-Star Enhancement Scroll’.

In an embodiment, the game-providing device may obtain an enhancement item enhanced using a second auxiliary item. Meanwhile, because an operation of enhancing an equipment item by applying the second auxiliary item to the equipment item corresponds to the operation of enhancing the equipment item by applying the first auxiliary item of FIG. 3 to the equipment item, the same description thereof will be omitted.

Meanwhile, it has been explained as an example that the probability that additional enhancement is directly performed on the equipment item and is succeeded is the same as the probability that the second auxiliary item is generated. However, the probability that the second auxiliary item is generated may differ from the probability that additional enhancement is directly performed on the equipment item and is succeeded. Meanwhile, the probability that the second auxiliary item is generated may represent the probability that an enhancement with respect to the first auxiliary item is successfully performed in response to additional execution of an enhancement with respect to the equipment item and thus the second auxiliary item is generated.

In an embodiment, the probability that the second auxiliary item is generated may be greater or less than the probability that a direct additional enhancement is successfully performed with respect to the equipment item.

In an embodiment, considering a penalty that may occur when the equipment item is directly and additionally enhanced, the probability of generating the second auxiliary item may be less than the probability that a direct additional enhancement is successfully performed with respect to the equipment item. For example, when the probability that a direct additional enhancement is successfully performed with respect to the equipment item to be enhanced is 30.0%, and there is a penalty of destroying equipment when the enhancement fails, the probability that the second auxiliary item is generated may be 5.0%.

In an embodiment, the probability of generating the second auxiliary item may be greater than the probability that a direct additional enhancement is successfully performed with respect to the equipment item. For example, when the probability that an additional enhancement is directly performed with respect to the equipment item to be enhanced and succeeds may be 20.0%, and the probability that the second auxiliary item is generated may be 25.0%.

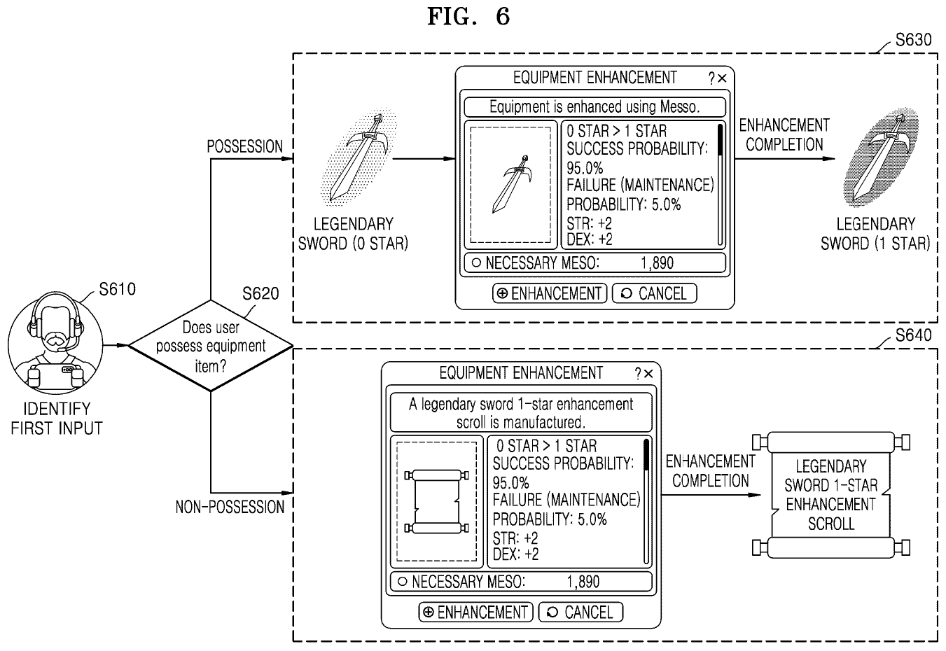

FIG. 6 is a view for explaining an operation of performing an enhancement according to whether an equipment item is possessed, according to an embodiment.

In an embodiment, the game-providing device may perform an enhancement in different ways according to whether an equipment item that is to be enhanced is possessed. For example, when the game-providing device possesses the equipment item that is to be enhanced, the game-providing device may directly perform enhancement with respect to the equipment item that is to be enhanced, based on a first input. When the game-providing device possesses the equipment item that is to be enhanced, the game-providing device may enhance the equipment item by additionally obtaining a third input that determines whether to generate the first auxiliary item in addition to the first input. When the game-providing device does not possess the equipment item that is to be enhanced, the game-providing device may reflect a result of enhancing the equipment item, based on the first input, to generate the first auxiliary item that enhances the equipment item.

In operation S610, the game-providing device may identify the first input for enhancing the equipment item. For example, the game-providing device may identify the first input from the user. Because operation S610 corresponds to operation S420, a redundant description thereof will be omitted.

In operation S620, the game-providing device may identify whether the user possesses the equipment item that is to be enhanced, based on the first input.

In an embodiment, the game-providing device may obtain information about the equipment item that is to be enhanced, from the enhancement information of the user. The game-providing device may identify whether the user possesses the equipment item, by identifying whether the equipment item that is to be enhanced is included in the user's item inventory.

In an embodiment, the game-providing device may perform operation S630, based on the user being identified as possessing the equipment item. The game-providing device may perform operation S640, based on the user being identified as not possessing the equipment item.

In operation S630, the game-providing device may directly perform enhancement with respect to the equipment item that is to be enhanced, based on the user being identified as possessing the equipment item. For example, the game-providing device may provide the user with an interface for directly enhancing the ‘Legendary Sword’, based on the user being identified as possessing the ‘Legendary Sword’, which is the equipment item that is to be enhanced. Based on the provision of the interface for directly enhancing the ‘legendary sword’, the game-providing device may obtain a user input for directly enhancing the ‘legendary sword’ to thereby perform enhancement with respect to the legendary sword.

In operation S640, the game-providing device may generate a first auxiliary item that enhances the equipment item, based on the user being identified as not possessing the equipment item. For example, the game-providing device may provide the user with an interface for generating the ‘Legendary Sword 1-Star Enhancement Scroll’, which is the first auxiliary item, based on the user being identified as not possessing the ‘Legendary Sword’. Based on the provision of the interface for generating the ‘Legendary Sword 1-Star Enhancement Scroll’, the game-providing device may obtain a user input for generating the ‘Legendary Sword 1-Star Enhancement Scroll’ to perform enhancement with respect to the legendary sword, thereby obtaining the ‘Legendary Sword 1-Star Enhancement Scroll’.

Whether or not to provide different interfaces according to whether the equipment item that is to be enhanced is possessed may be previously set in the game-providing device.

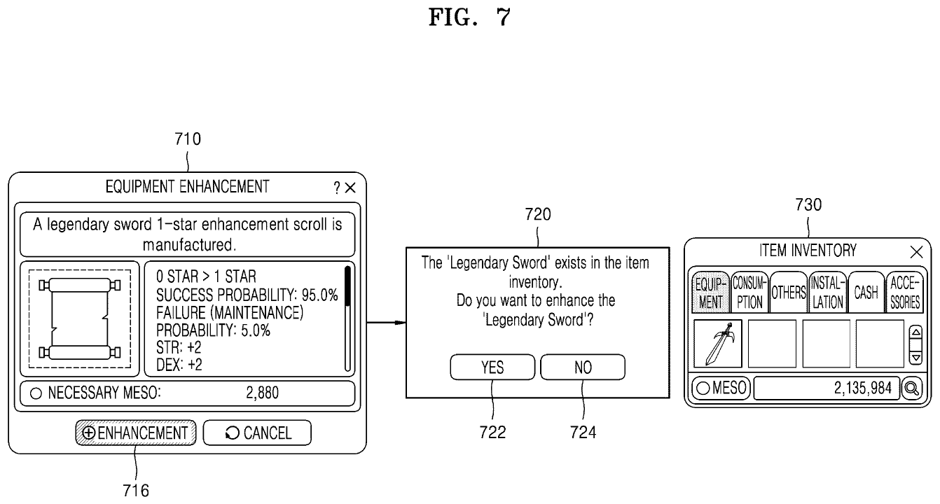

FIG. 7 is a view for explaining an operation of performing an enhancement according to whether an equipment item is possessed, according to an embodiment.

In an embodiment, the game-providing device may obtain a user interface 710 (hereinafter, referred to as an enhancement interface) including enhancement information. The enhancement interface 710 may include an enhancement banner 716 for obtaining a first input.

In an embodiment, the game-providing device may obtain the first input as a user input for an enhancement banner. The game-providing device may identify whether the user possesses the equipment item that is to be enhanced, based on identification of the first input. When the game-providing device identifies the user as possessing the equipment item that is to be enhanced, the game-providing device may provide the user with a query interface 720 that includes a query as to whether to directly enhance the equipment item.

In an embodiment, the query interface 720 may include a first banner 722 allowing the user to directly perform enhancement on the equipment item, while providing the user with information about whether or not the equipment item is possessed. The query interface 720 may include a second banner 724 that determines whether to generate the first auxiliary item. A user input for the second banner 724 may be a third input that determines whether to generate the first auxiliary item, based on the equipment item being identified as being possessed by the user.

In an embodiment, the third input for determining whether to generate the first auxiliary item may be an input for determining whether to generate the first auxiliary item, by reflecting a result of performing enhancement on an item that is to be enhanced. Accordingly, the game-providing device may perform an enhancement with respect to the item that is to be enhanced, based on the third input, and may generate the first auxiliary item when the enhancement has been successfully performed. An operation of generating the first auxiliary item, based on the third input, may correspond to an operation of generating the first auxiliary item that enhances the equipment item by reflecting a result of enhancing the equipment item, based on the enhancement information and the first input.

The first input, the second input, and the third input are only described using ordinal numbers for the purpose of distinguishing them from each other, and are not limited by the terms.

In an embodiment, the query interface 720 may provide the user with a message asking whether to directly enhance the equipment item, which is “Do you want to enhance the ‘Legendary Sword’ directly?” along with a message “The ‘Legendary Sword’ exists in the item inventory.”, as information about whether the equipment item is possessed.

In an embodiment, the query interface 720 may include a banner containing ‘Yes’ as the first banner 722 and a banner containing ‘No’ as the second banner 724.

In an embodiment, when the game-providing device identifies the user as possessing the equipment item that is to be enhanced, the game-providing device may provide an inventory interface 730 including an in-game item inventory window while providing the query interface 720.

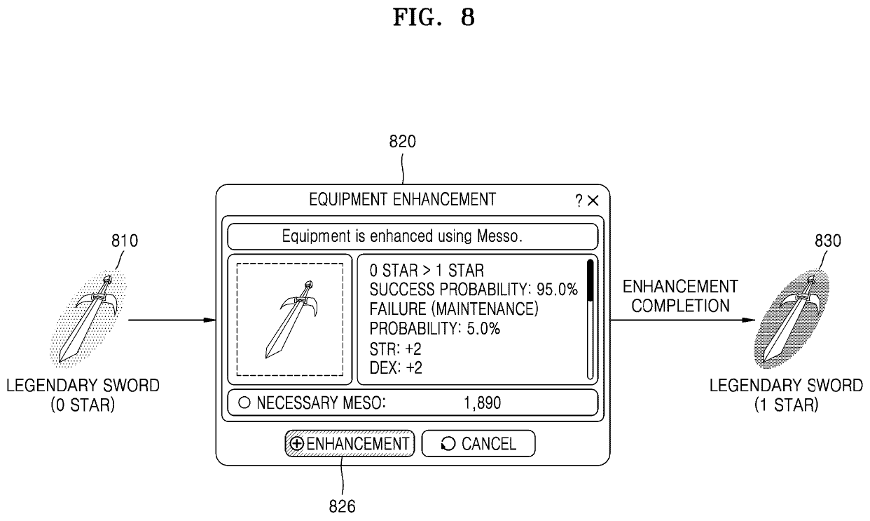

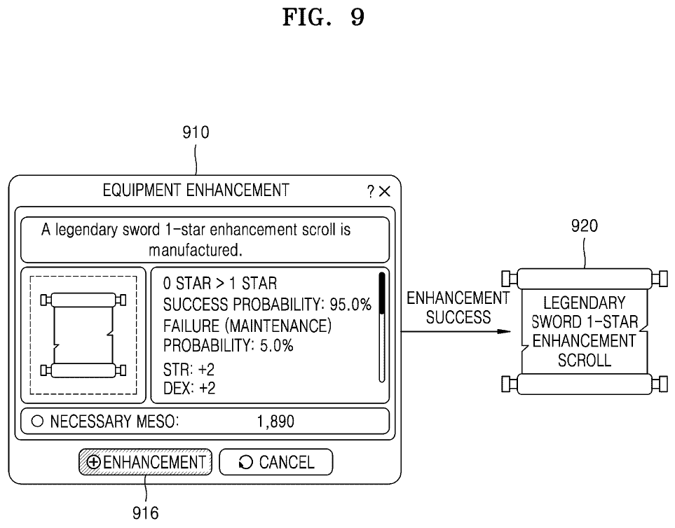

An interface provided in response to identification of an input for the query interface 720 will now be described in detail with reference to FIGS. 8 and 9.

FIG. 8 is a view for explaining an operation of performing an enhancement according to whether an equipment item is possessed, according to an embodiment.

In an embodiment, in response to provision of a query interface, the game-providing device may provide a direct enhancement interface 820 for directly enhancing the equipment item, when an input for the first banner allowing execution of direct enhancement is obtained.

In an embodiment, the game-providing device performs enhancement with a success probability of 95.0% with respect to a 0-star legendary sword 810, which is the equipment item, based on identifying an input for an enhancement banner 826 included in the direct enhancement interface 826, and, when the enhancement is successfully performed, may obtain or generate a 1-star legendary sword 830, which is an enhanced equipment item.

Am operation of directly performing enhancement is not limited to the above-described exemplary methods.

FIG. 9 is a view for explaining an operation of performing an enhancement according to whether an equipment item is possessed, according to an embodiment.

In an embodiment, in response to provision of a query interface, the game-providing device may obtain an input for a second banner allowing to generate the first auxiliary item. When the game-providing device obtains the input for the second banner, the game-providing device may provide an enhancement interface 910 including enhancement information. Because the enhancement interface 910 corresponds to the user interface 210 of FIG. 2, a redundant description thereof will be omitted.

In an embodiment, the game-providing device may identify an input for an enhancement banner 916 included in the enhancement interface 910, and the game-providing device may perform enhancement with a success probability of 95.0% with respect to a legendary sword, based on identifying the input for the enhancement banner 916, and, when the enhancement is successfully performed, may obtain a legendary sword 1-star enhancement scroll, which is a first auxiliary item 920.

FIG. 10 is a view for explaining a method of setting a validity period for an auxiliary item, according to an embodiment.

In an embodiment, when generating an auxiliary item, the game-providing device may set a validity period during which the user is able to possess the auxiliary item, based on a time point when the auxiliary item has been generated.

In an embodiment, according to the type of equipment item that is to be enhanced, the validity period of the auxiliary item may be set differently, and the validity period may be set differently for each item. For example, the validity period of the ‘Legendary Sword 1-Star Enhancement Scroll’, which is an auxiliary item for the ‘Legendary Sword’ item, may be set to be 6 months from the time of generation of the ‘Legendary Sword 1-Star Enhancement Scroll’. The validity period of a ‘Noble Ring 1-Star Enhancement Scroll’, which is an auxiliary item for a ‘Noble Ring’ item, may be set to be 3 months from the time of generation of the ‘Noble Ring 1-Star Enhancement Scroll’.

In an embodiment, the validity period of the auxiliary item may be set differently according to information associated with enhancement included in the auxiliary item. For example, the validity period of the ‘Legendary Sword 1-Star Enhancement Scroll’ may be set to be 5 months from the time of generation of the ‘Legendary Sword 1-Star Enhancement Scroll’. The validity period of the ‘Legendary Sword 2-star Enhancement Ticket’ may be set to be 4 months from the time of generation of the ‘Legendary Sword 1-star Enhancement Ticket’. In an embodiment, the game-providing device may generate a first auxiliary item 1010. The game-providing device may set a first validity period 1014 based on a time point when the first auxiliary item 1010 is generated. The first validity period 1014 may indicate a period during which the user is able to possess the first auxiliary item 1010.

In an embodiment, the first validity period 1014 corresponding to the first auxiliary item 1010 may be previously set to be a selected period from a generation time 1012 when the first auxiliary item is generated. For example, the first validity period 1014 may be previously set to be 6 months from the generation time 1012 when the first auxiliary item is generated. Therefore, when the generation time 1012 when the first auxiliary item is generated is 16:52 on Aug. 8, 2023, the first validity period 1014 may be 16:52 on Feb. 8, 2024.

In an embodiment, the game-providing device may perform enhancement on the first auxiliary item 1010, and, when the enhancement is successfully performed, may generate a second auxiliary item 1020. In response to generating the second auxiliary item 1020, the game-providing device may update the second validity period 1024, based on a generation time 1022 at which the second auxiliary item is generated. The second validity period 1024 may indicate a period during which the user is able to possess the second auxiliary item 1020.

In an embodiment, the game-providing device successfully enhancing the first auxiliary item 1010 and thus generating the second auxiliary item 1020 may be destroying the first auxiliary item 1010 and generating the second auxiliary item 1020. Accordingly, when generating the second auxiliary item 1020, the game-providing device may update the first validity period 1014 of the first auxiliary item 1010 with the second validity period 1024.

In an embodiment, the second validity period 1024 corresponding to the second auxiliary item 1020 may be previously set to be a selected period from the generation time 1022 when the second auxiliary item is generated. For example, the second validity period 1024 may be previously set to be 6 months from the generation time 1022 when the second auxiliary item is generated. Therefore, when the generation time 1022 when the second auxiliary item is generated is 17:26 on Sep. 8, 2023, the second validity period 1024 may be 17:26 on Mar. 8, 2024.

In an embodiment, when generating the second auxiliary item 1020, the game-providing device may update ‘16:52 on Feb. 8, 2024’, which is the first validity period 1014 of the first auxiliary item 1010, with ‘17:26 on Mar. 8, 2024’, which is the second validity period 1024.

In an embodiment, the game-providing device may destroy the first auxiliary item 1010 or the second auxiliary item 1020, when the first validity period 1014 or the second validity period 1024 expires.

In an embodiment, a validity period may be set for an auxiliary item in order to prevent auxiliary items from being accumulated. When a validity period is set for an auxiliary item, the user's use or sale of the auxiliary item may be promoted, and execution of enhancement for in-game equipment items may be activated.

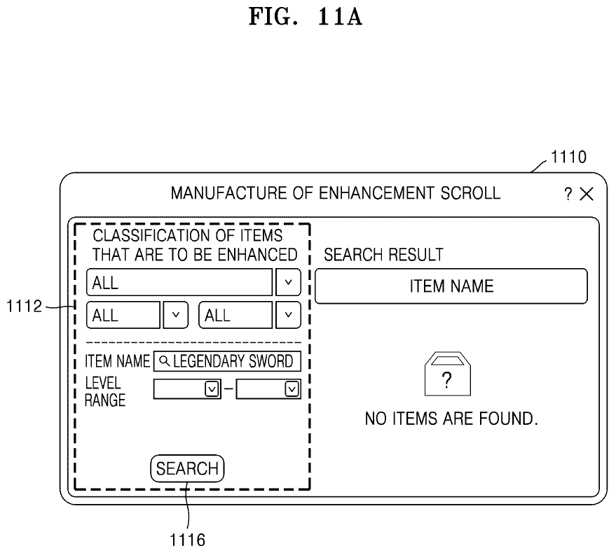

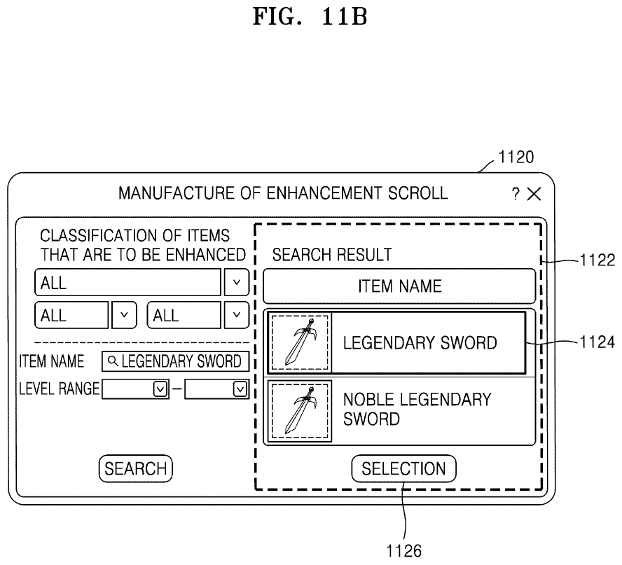

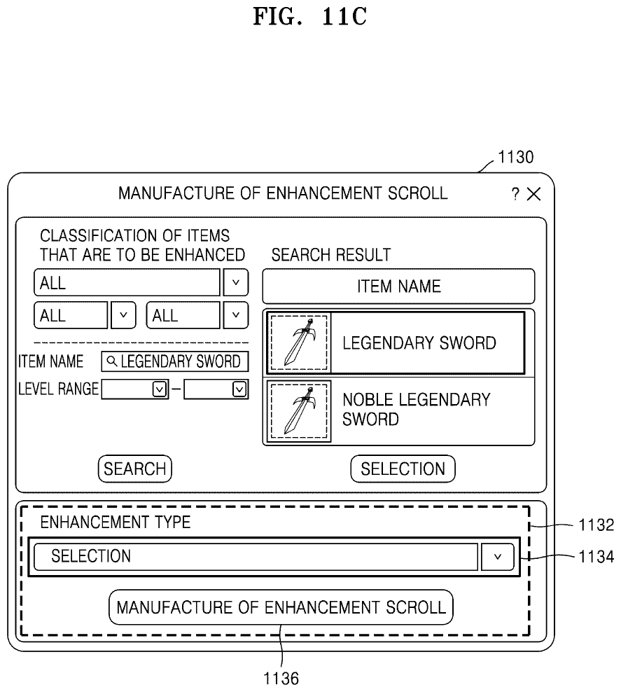

FIGS. 11A through 11C are diagrams for explaining user interfaces for generating a first auxiliary item, according to an embodiment.

FIG. 11A is a diagram for explaining a user interface for generating a first auxiliary item.

In an embodiment, the game-providing device may provide a first enhancement interface 1110 for generating a first auxiliary item. The first enhancement interface 1110 may include a search block 1112 for searching for an equipment item that is to be enhanced, in order to obtain enhancement information. The game-providing device may receive information about at least one item included in the search block 1112 and may search for the equipment item that is to be enhanced. The search block may include, but is not limited to, at least one of the classification of items to be enhanced, item names, and item-wearable levels.

In an embodiment, the classification of items to be enhanced included in the search block may be selecting detailed classifications such as weapons, armor, accessories, clothes, etc. to specify an item that is to be enhanced.

In an embodiment, the item names included in the search block may be used to search for the item to be enhanced, when the user clearly recognizes the name of an item or recognizes a word included in the name of the item.

In an embodiment, the game-providing device may obtain a user input for a search banner 1116 from a user who has described at least one item included in the search block 1112. The game-providing device may perform a search with respect to the equipment item that is to be enhanced, by obtaining a user input for the search block 1112. The game-providing device may provide the first enhancement interface 1110 including a message ‘No items are found.’, before obtaining the user input for the search banner 1116. When a search for the equipment item to be enhanced in response to the search banner 1116 is performed but there are no search results, the game-providing device may provide the first enhancement interface 1110 including a message ‘No items are found.’

A second enhancement interface 1120 providing a search result including information about at least one equipment item through execution of a search for the equipment item to be enhanced by the game-providing device will now be described in detail with reference to FIG. 11B.

FIG. 11B is a diagram for explaining a user interface for generating a first auxiliary item.

In an embodiment, the game-providing device may provide the second enhancement interface 1120 for generating a first auxiliary item. The second enhancement interface 1120 may include a search result block 1122 obtained using the search block 1112. The search result block 1122 may include a result of extracting the equipment item that the user wants to enhance from a database within a game, by analyzing information obtained using the search block 1112. For example, when the user has found an item name ‘legendary sword’ by using the search block 1112, the game-providing device may extract item information including all items including a word ‘legendary sword’ from the database within the game. The item information including all items containing the word ‘legendary sword’ may include information about items ‘legendary sword’ and ‘noble legendary sword’.

In an embodiment, the game-providing device may obtain a user input for selecting an item banner 1124 corresponding to one equipment item from among equipment items provided to the search result block 1122. For example, the game-providing device may obtain a user input for selecting an item banner corresponding to ‘legendary sword’.

In an embodiment, the game-providing device may obtain a user input for a selection banner 1126 for performing enhancement on an equipment item (hereinafter, referred to as a selected item) that is selected to be enhanced from among the provided equipment items.

When the game-providing device obtains the user input for the search banner 1126, the game-providing device may provide a third enhancement interface 1130 for obtaining enhancement information.

FIG. 11C is a diagram for explaining a user interface for generating a first auxiliary item.

In an embodiment, the game-providing device may provide a third enhancement interface 1130 for generating a first auxiliary item. The third enhancement interface 1130 may include an enhancement block 1132 in response to selection of one item from the search result block 1122. The enhancement block 1132 may include information about the type of enhancement that may be performed on the selected item.

In an embodiment, the game-providing device may obtain an input for the type of at least one enhancement from an enhancement type tab 1134. When the game-providing device receives an enhancement for each level as the type of enhancement, the game-providing device may also obtain an input for the level of enhancement that is to be performed.

In an embodiment, when the game-providing device obtains an input for a production banner 1136 for generating the first auxiliary item, by reflecting a result of performing enhancement on the equipment item, the game-providing device may provide the enhancement interface 210 of FIG. 2.

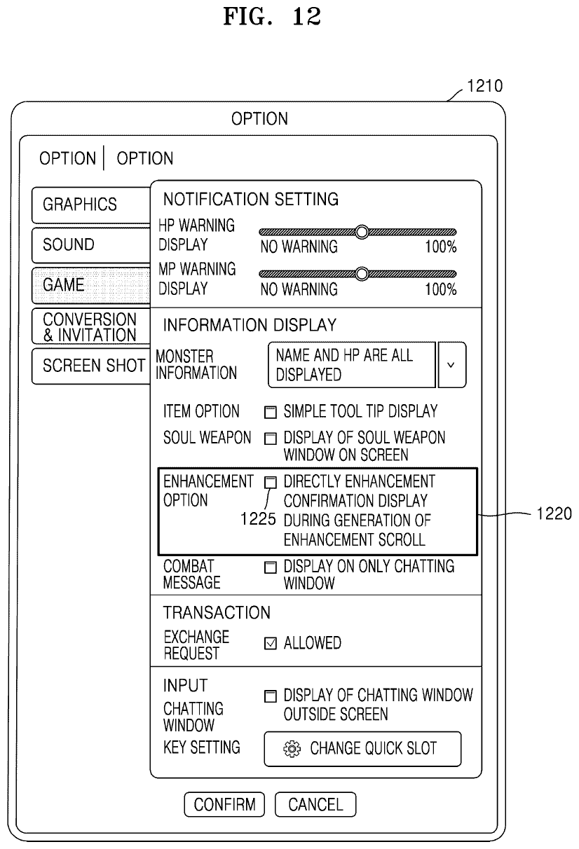

FIG. 12 is a diagram for explaining an operation of setting a default value associated with enhancement, according to an embodiment.

In an embodiment, the game-providing device may provide an option interface 1210 in order to set a default value associated with enhancement. For example, as an enhancement option 1220, the game-providing device may set a default value regarding whether to provide the query interface 720 of FIG. 7 to the user, when the game-providing device identifies a first input. When the game-providing device identifies that the user possesses the equipment item that is to be enhanced, the game-providing device may provide the user with the enhancement interface 1220 for setting a default value regarding whether to provide a query interface to the user.

In an embodiment, when a ‘direct enhancement confirmation display during generation of an enhancement scroll’ item 1225 has been checked, the game-providing device may provide a query interface according to the situation. For example, when the first input is identified and then the user is identified as having an equipment item that is to be enhanced, the game-providing device may provide a query interface to the user. On the other hand, when the ‘direct enhancement confirmation display during generation of enhance scroll’ item 1225 has been unchecked, the game-providing device may provide no query interfaces. For example, even when the first input is identified, the game-providing device may provide no query interfaces to the user regardless of whether the user has the equipment item that is to be enhanced.

In an embodiment, an enhancement option is not limited to the disclosed example, and may include an item that may be previously set by the user's selection in relation to an enhancement according to the disclosure.

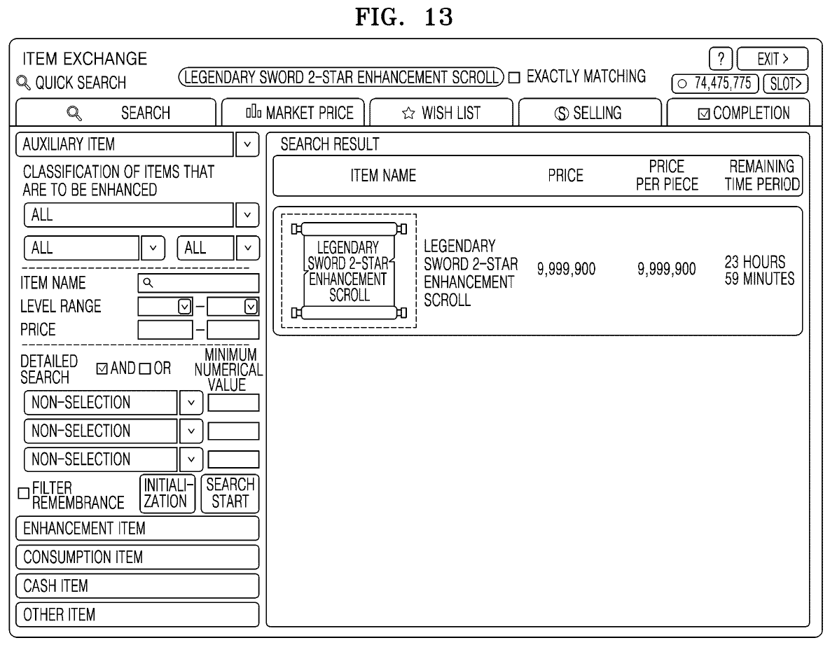

FIG. 13 is a diagram for explaining a user interface for purchasing or selling an auxiliary item, according to an embodiment.

In an embodiment, the game-providing device may purchase or sell auxiliary items (including a first auxiliary item and a second auxiliary item) through an item exchange.

In an embodiment, the game-providing device may search for an item that is sold on the item exchange by at least one search element among the name of the auxiliary item, the effect of the auxiliary item, the name of the equipment item to be enhanced by the auxiliary item, and the price of the auxiliary item. The game-providing device may allow the user to purchase the auxiliary item through the item exchange. The game-providing device may also allow the user to sell the auxiliary item through the item exchange. The game-providing device may also allow users to directly trade auxiliary items without using the item exchange.

In an embodiment, when the user determines that an equipment item is possessed but it is cumbersome to perform enhancement or determines that it is more appropriate to perform enhancement on the equipment item by using an auxiliary item than directly enhancing the equipment item, the user may purchase the auxiliary item. Additionally, users may be able to determine the market value of auxiliary items and purchase and sell auxiliary items at appropriate prices.

In an embodiment, an action of purchasing an auxiliary item may be considered as a factor in determining the enhancement costs calculated based on the user's demand. For example, when the enhancement costs are determined considering the number of transactions of auxiliary items, the enhancement costs of the equipment item may be prevented from falling excessively compared to an in-game value even when the equipment item that is to be enhanced is insufficient. In addition, when the enhancement costs of the equipment item become stable, the market price of the equipment item may also be stabilized as a result.

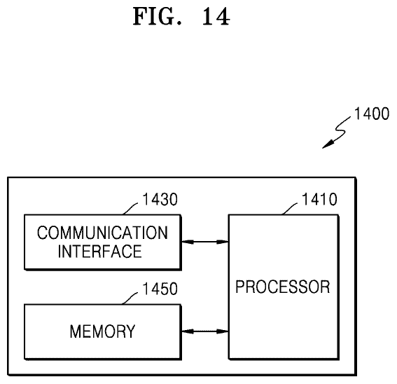

FIG. 14 is a block diagram of a detailed configuration of a game-providing device according to various embodiments.

Referring to FIG. 14, a game-providing device 1400 according to some embodiments may include at least one processor 1410, a communication interface 1430, and a memory 1450. Not all of the components illustrated in FIG. 14 are essential components of the game-providing device 1400. More or less components than those illustrated in FIG. 14 may constitute the game-providing device 1400. The game-providing device 1400 may be a user terminal, a server, a game network system, or a separate device.

According to an embodiment, the processor 1410 typically controls an overall operation of the game-providing device 1400. For example, the processor 1410 may generally control the communication interface 1430, the memory 1450, etc. by executing a program stored in the memory 1450. The processor 1410 may control an operation of the game-providing device 1400 in this specification by controlling the communication interface 1430, the memory 1450, etc. The program stored in the memory 1450 may be instructions for the operation of the game-providing device 1400.

In an embodiment, the processor 1410 may obtain enhancement information indicating information associated with the enhancement of an equipment item that is to be enhanced from among in-game items, identify a first input for enhancing the equipment item, and generate a first auxiliary item for enhancing the equipment item, by reflecting a result of enhancing the equipment item, based on the enhancement information and the first input.

In an embodiment, as the processor 1410 identifies the first input from the user, the processor 1410 may perform enhancement on the equipment item independently of whether the user possesses the equipment item, and may generate the first auxiliary item, based on successful enhancement with respect to the equipment item.

In an embodiment, the processor 1410 may identify a second input for enhancing the first auxiliary item, in order to additionally enhance the equipment item, and generate a second auxiliary item for enhancing the equipment item, by reflecting a result of enhancing the first auxiliary item, based on the enhancement information and the second input.

In an embodiment, the processor 1410 may identify whether the user possesses the equipment item based on identifying the first input, and may generate the first auxiliary item based on identifying that the user does not possess the equipment item.

In an embodiment, the processor 1410 may obtain a third input of determining whether to generate the first auxiliary item, based on an identification that the user possesses the equipment item.

In an embodiment, the processor 1410 may set a first validity period indicating a period during which the user is able to possess the first auxiliary item, for the first auxiliary item, based on a time point when the first auxiliary item is generated.

In an embodiment, the processor 1410 may update a second validity period indicating a period during which the user is able to possess the second auxiliary item, based on a time point when the second auxiliary item is generated, in correspondence with generation of the second auxiliary item through enhancement on the first auxiliary item.

In an embodiment, the processor 1410 may enhance the equipment item by applying the first auxiliary item to the equipment item.

In an embodiment, the communication interface 1430 may perform communication with an external device under a control by the processor 1410. For example, the communication interface 1430 may perform communication with an external device, such as a payment server or an authentication server, under a control by the processor 1410. The communication interface 1430 may obtain user information or a user input through communication with an external interface.

In an embodiment, the memory 1450 may store a program used by the processor 1410 to perform processing and control, and may also store data that is input to or output from the game-providing device 1400. According to an embodiment, the memory 1450 may store item information about items in the game, enhancement information related to enhancement of the equipment items, item inventory information for each user, etc.

In an embodiment, the processor 1410 may perform a method of providing a game service, by using the program stored in the memory 1450. For example, when the processor 1410 identifies a first input for enhancing the equipment item, based on the enhancement information stored in the memory 1450, the processor 1410 may reflect a result of enhancing the equipment item, to generate the first auxiliary item for enhancing the equipment item. When a second input is identified, based on the enhancement information stored in the memory 1450, the processor 1410 may reflect a result of enhancing the first auxiliary item, to generate the second auxiliary item.

According to an embodiment, the memory 1450 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. In an embodiment, the programs stored in the memory 1450 may be classified into a plurality of modules according to their functions.

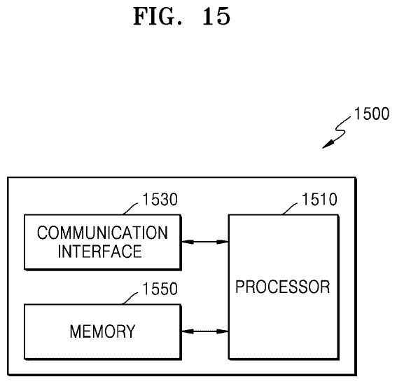

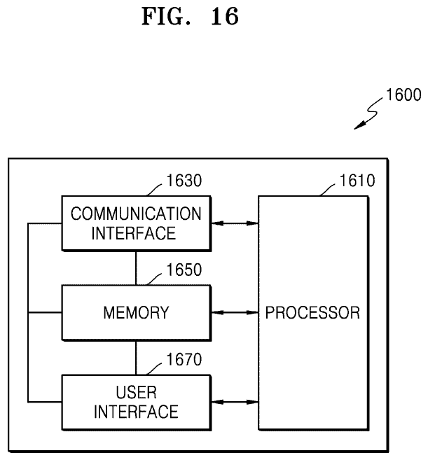

According to an embodiment, a method of providing a game service may be performed in the game-providing device 1400 or in a server or a user terminal, and at least one component included in the game-providing device 1400 may perform the embodiments described above with reference to FIGS. 1 through 13. The method of providing a game service may be performed individually or jointly by the server and the user terminal. Respective configurations of the server and user terminal will now be described in more detail with reference to FIGS. 15 and 16.

FIG. 15 is a block diagram of a detailed configuration of a game-providing device according to various embodiments.

Referring to FIG. 15, a server 1500 according to some embodiments may include at least one processor 1510, a communication interface 1530, and a memory 1550. Not all of the components illustrated in FIG. 15 are essential components of the server 1500. More or less components than those illustrated in FIG. 15 may constitute the server 1500.

According to an embodiment, the processor 1510 typically controls an overall operation of the server 1500. For example, the processor 1510 may generally control the communication interface 1530, the memory 1550, etc. by executing a program stored in the memory 1550. The processor 1510 may control an operation of the server 1500 in this specification by controlling the communication interface 1530, the memory 1550, etc.

According to an embodiment, the processor 1510 may obtain enhancement information indicating information associated with the enhancement of an equipment item that is to be enhanced from among in-game items, identify a first input for enhancing the equipment item, and generate a first auxiliary item for enhancing the equipment item, by reflecting a result of enhancing the equipment item, based on the enhancement information and the first input.

According to an embodiment, an operation of the processor 1510 may correspond to an operation of the processor 1410 of the game-providing device 1400 described above with reference to FIG. 14, so a detailed description thereof will be omitted.

The communication interface 1530 may provide a query to a user terminal 1600 under a control by the processor 1510, and may receive response information for the query. According to an embodiment, the communication interface 1530 may transmit and receive data to and from the user terminal 1600, and the data transmitted and received to and from the user terminal 1600 may include control data that controls the user terminal 1600 or a program included in the user terminal 1600.

The memory 1550 may store a program used by the processor 1510 to perform processing and control, and may also store data that is input to or output from the server 1500. According to an embodiment, the memory 1550 may store, for example, item information about items in the game, enhancement information related to enhancement of the equipment items.

According to an embodiment, the processor 1510 may perform a method of providing a game service, by using the program stored in the memory 1550.

According to an embodiment, the memory 1550 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. According to an embodiment, the programs stored in the memory 1550 may be classified into a plurality of modules according to their functions.

According to an embodiment, a game-providing method may be performed by the server 1500 and the user terminal 1600 together, may be performed individually by the server 1500 and the user terminal 1600, or may be performed by the game-providing device 1400.

FIG. 16 is a block diagram of a detailed configuration of a user terminal according to various embodiments.

Referring to FIG. 16, the user terminal 1600 according to some embodiments may include at least one processor 1610, a communication interface 1630, a memory 1650, and a user interface 1670. Not all of the components illustrated in FIG. 16 are essential components of the user terminal 1600. More or less components than those illustrated in FIG. 16 may constitute the user terminal 1600.

According to an embodiment, the processor 1610 typically controls an overall operation of the user terminal 1600. For example, the processor 1610 may generally control the communication interface 1630, the memory 1650, the user interface 1670, etc. by executing a program stored in the memory 1650. The processor 1610 may control an operation of the user terminal 1600 in this specification by controlling the communication interface 1630, the memory 1650, the user interface 1670, etc.

According to an embodiment, the processor 1610 may obtain enhancement information indicating information associated with the enhancement of an equipment item that is to be enhanced from among in-game items, identify a first input for enhancing the equipment item, and generate a first auxiliary item for enhancing the equipment item, by reflecting a result of enhancing the equipment item, based on the enhancement information and the first input.

According to an embodiment, an operation of the processor 1610 may correspond to an operation of the processor 1410 of the game-providing device 1400 described above with reference to FIG. 14, so a detailed description thereof will be omitted.

The communication interface 1630 may provide a query to the server 1500 under a control by the processor 1610, and may receive response information for the query. According to an embodiment, the communication interface 1630 may transmit and receive data to and from the server 1500, and the data transmitted and received to and from the server 1500 may include control data that controls the user terminal 1600 or a program included in the user terminal 1600.

According to an embodiment, the communication interface 1630 may include, but is not limited to, a Bluetooth communication interface, a Bluetooth Low Energy (BLE) communication interface, a near field communication (NFC) interface, a wireless local area network (WLAN) (e.g., Wi-Fi) communication interface, a ZigBee communication interface, an infrared Data Association (IrDA) communication interface, a Wi-Fi direct (WFD) communication interface, an ultrawideband (UWB) communication interface, and an Ant+ communication interface.

According to an embodiment, the communication interface 1630 transmits or receives wireless signals to or from at least one selected from a base station, an external terminal, and a server on a mobile communication network. Examples of the wireless signal may include a voice call signal, a video call signal, and various types of data according to text/multimedia message exchange.

The memory 1650 may store a program used by the processor 1610 to perform processing and control, and may also store data that is input to or output from the user terminal 1600. According to an embodiment, the memory 1650 may store game-related information. For example, the memory 1650 may store, for example, item information about items in the game, enhancement information related to enhancement of the equipment items.

According to an embodiment, the processor 1610 may perform a method of providing a game service, by using the program stored in the memory 1650.

According to an embodiment, the memory 1650 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. According to an embodiment, the programs stored in the memory 1650 may be classified into a plurality of modules according to their functions.

According to an embodiment, the user interface 1670 may include various interfaces. For example, the user interface 1670 may include various interfaces, such as a key pad, a dome switch, a voice input interface, a fingerprint input interface, a touch input interface (e.g., a capacitive overlay type, a resistive overlay type, an infrared beam type, a surface acoustic wave type, an integral strain gauge type, or a piezo electric type), a camera, a jog wheel, and a jog switch, and may link various sensors, such as an acceleration sensor, a position sensor, a temperature sensor, and an optical sensor. Of course, embodiments are not limited thereto.

According to an embodiment, the user interface 1670 may further include an output interface (not shown). The output interface may include at least one selected from a liquid crystal display (LCD), a thin film transistor-liquid crystal display (TFT-LCD), an organic light-emitting diode (OLED), a flexible display, a three-dimensional (3D) display, and an electrophoretic display. When a display forms a layer structure together with a touch pad to construct a touch screen, the display may be used as an input device as well as an output device. The output interface may include, but is not limited to, an LED lamp, a vibration motor, a speaker, a flash, etc.

According to an embodiment, the user interface 1670 may output a notification about game information in the form of an image, a video, a sound, a vibration, a lamp, etc.

According to an embodiment, the user interface 1670 may include the enhancement interface 210 of FIG. 2, the enhancement interface 510 of FIG. 5, the enhancement interface 710 of FIG. 7, the query interface 720 of FIG. 7, the inventory interface 730 of FIG. 7, the direct enhancement interface 820 of FIG. 8, the enhancement interface 910 of FIG. 9, the first enhancement interface 1110 of FIG. 11A, the second enhancement interface 1120 of FIG. 11B, and the third enhancement interface 1130 of FIG. 11C, and the option interface 1210 of FIG. 12. However, the aforementioned interfaces have been described as examples of the user interface 1670, and the user interface 1670 according to the disclosure may include more diverse interfaces.

Through various embodiments, user participation in enhancement of items may be encouraged by providing various enhancement methods to an in-game system. Furthermore, by allowing users to perform enhancement without restrictions on the mobility of items, users' demand for enhancement with respect to items with low mobility may be measured.

The device described above (e.g., the game-providing device, the server, or the user terminal) may be implemented as a hardware component, a software component, and/or a combination of hardware components and software components. For example, the devices and components described in the embodiments may be implemented using at least one general-use computer or special-purpose computer, such as, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. A processing device (e.g., at least one processor) may execute an operating system (OS) and one or more software applications running on the OS. In addition, the processing device may access, store, manipulate, process, and generate data in response to execution of software. For ease of understanding, a single processing device may be described as being used, but one of ordinary skill in the art will recognize that the processing device may include a plurality of processing elements and/or a plurality of types of processing elements. For example, the processing device may include a plurality of processors or a single processor, and a controller. The processing device (e.g., at least one processor) may have another processing configuration, such as a parallel processor.

The software may include a computer program, a code, instructions, or a combination of one or more of the foregoing, and may configure a processing device so that the processing device can operate as intended, or independently or collectively give instructions to the processing device. The software and/or the data may be permanently or temporarily embodied in any type of machine, component, physical device, virtual equipment, computer storage media or devices, or transmitted signal waves, such that the software and/or the data is interpreted by the processing device or provides an instruction or data to the processing device. The software may be distributed over a networked computer system and stored or executed in a distributed manner. The software and the data may be stored on one or more computer readable recording media.

A method according to an example may be embodied as program commands executable by various computer means and may be recorded on a computer-readable recording medium. The computer-readable recording medium may include program commands, data files, data structures, and the like separately or in combinations. The program commands to be recorded on the computer-readable recording medium may be specially designed and configured for examples or may be well-known to and be usable by one of ordinary skill in the art of computer software. Examples of a computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as a floptical disk, and a hardware device specially configured to store and execute program commands such as a ROM, a random-access memory (RAM), or a flash memory. Examples of the program commands are high-level language codes that can be executed by a computer by using an interpreter or the like as well as machine language codes made by a compiler. The hardware devices can be configured to function as one or more software modules so as to perform operations according to examples, or vice versa.

While the disclosure has been particularly shown and described with reference to examples thereof, it will be understood by those of ordinary skill in the art that various changes in form and details may be made therein without departing from the spirit and scope of the disclosure. For example, an appropriate result may be attained even when the above-described techniques are performed in a different order from the above-described method, and/or components, such as the above-described system, structure, device, and circuit, are coupled or combined in a different form from the above-described methods or substituted for or replaced by other components or equivalents thereof.

Therefore, other implementations, other embodiments, and equivalents of the claims also fall within the scope of the claims described below.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, performed by a game-providing device, of providing a game service, the method comprising:
obtaining enhancement information indicating information associated with enhancement of an equipment item that is to be enhanced from among items in a game;
identifying a first input for enhancing the equipment item; and
generating, based on the enhancement information and the first input, a first auxiliary item for enhancing the equipment item by reflecting a result of enhancing the equipment item.

2. The method of claim 1, wherein the generating of the first auxiliary item comprises:
in response to the first input being identified from a user, performing enhancement with respect to the equipment item independently of whether the user possesses the equipment item; and
generating the first auxiliary item based on a successful execution of the enhancement with respect to the equipment item.

3. The method of claim 1, further comprising:
identifying a second input for enhancing the first auxiliary item; and
generating, based on the enhancement information and the second input, a second auxiliary item for enhancing the equipment item by reflecting a result of enhancing the first auxiliary item.

4. The method of claim 3, wherein
the first auxiliary item and the second auxiliary item ensure the enhancement of the equipment item, and
the second auxiliary item is different from the first auxiliary item.

5. The method of claim 1, wherein the generating of the first auxiliary item comprises:
identifying whether a user possesses the equipment item based on identification of the first input; and
generating the first auxiliary item based on identifying that the user does not possess the equipment item.

6. The method of claim 5, wherein the generating of the first auxiliary item comprises obtaining a third input of determining whether to generate the first auxiliary item based on identifying that the user possesses the equipment item.

7. The method of claim 3, further comprising setting, based on a time point when the first auxiliary item is generated, a first validity period indicating a period during which the user is able to possess the first auxiliary item for the first auxiliary item.

8. The method of claim 7, further comprising updating, based on a time point when the second auxiliary item is generated, a second validity period indicating a period during which the user is able to possess the second auxiliary item in correspondence with generation of the second auxiliary item through enhancement on the first auxiliary item.

9. The method of claim 1, further comprising enhancing the equipment item by applying the first auxiliary item to the equipment item.

10. A game-providing device, comprising:
a memory storing instructions; and
at least one processor functionally connected to the memory and configured to execute the instructions,
wherein the at least one processor is configured to execute the instructions to:
obtain enhancement information indicating information associated with enhancement of the equipment item that is to be enhanced from among items in a game;
identify a first input for enhancing the equipment item; and
generate, based on the enhancement information and the first input, a first auxiliary item for enhancing the equipment item by reflecting a result of enhancing the equipment item.

11. The game-providing device of claim 10, wherein the at least one processor is further configured to execute the instructions to,
in response to the first input being identified from a user, perform enhancement with respect to the equipment item independently of whether the user possesses the equipment item, and
generate the first auxiliary item based on successful execution of the enhancement with respect to the equipment item.

12. The game-providing device of claim 10, wherein the at least one processor is further configured to execute the instructions to:
identify a second input for enhancing the first auxiliary item; and
generate, based on the enhancement information and the second input, a second auxiliary item for enhancing the equipment item by reflecting a result of enhancing the first auxiliary item.

13. The game-providing device of claim 12, wherein
the first auxiliary item and the second auxiliary item ensure the enhancement of the equipment item, and
the second auxiliary item is different from the first auxiliary item.

14. The game-providing device of claim 10, wherein the at least one processor is further configured to execute the instructions to:
identify whether a user possesses the equipment item based on identification of the first input; and
generate the first auxiliary item based on identifying that the user does not possess the equipment item.

15. The game-providing device of claim 14, wherein the at least one processor is further configured to execute the instructions to obtain, based on identifying that the user possesses the equipment item, a third input of determining whether to generate the first auxiliary item.

16. The game-providing device of claim 12, wherein the at least one processor is further configured to set based on a time point when the first auxiliary item is generated, a first validity period indicating a period during which a user is able to possess the first auxiliary item for the first auxiliary item.

17. The game-providing device of claim 16, wherein the at least one processor is further configured to update, based on a time point when the second auxiliary item is generated, a second validity period indicating a period during which the user is able to possess the second auxiliary item in correspondence with generation of the second auxiliary item through enhancement on the first auxiliary item.

18. The game-providing device of claim 10, wherein the at least one processor is further configured to enhance the equipment item by applying the first auxiliary item to the equipment item.

19. A server, comprising:
a memory storing instructions; and
at least one processor functionally connected to the memory and configured to execute the instructions,
wherein the at least one processor is configured to execute the instructions to:
obtain enhancement information indicating information associated with enhancement of the equipment item that is to be enhanced from among items in a game;
identify a first input for enhancing the equipment item; and
generate, based on the enhancement information and the first input, a first auxiliary item for enhancing the equipment item by reflecting a result of enhancing the equipment item.

20. A user terminal for providing a game service, the user terminal comprising:
a user interface configured to receive a user input;
a memory storing instructions; and
at least one processor functionally connected to the user interface and the memory and configured to execute the instructions,
wherein the at least one processor is configured to execute the instructions to:
obtain enhancement information indicating information associated with enhancement of the equipment item that is to be enhanced from among items in a game;
identify a first input for enhancing the equipment item; and
generate, based on the enhancement information and the first input, a first auxiliary item for enhancing the equipment item by reflecting a result of enhancing the equipment item.

21. A non-transitory computer-readable recording medium having recorded thereon a program, which, when executed by a computer, performs a method of providing a game service, the method comprising:
obtaining enhancement information indicating information associated with enhancement of an equipment item that is to be enhanced from among items in a game;
identifying a first input for enhancing the equipment item; and
generating, based on the enhancement information and the first input, a first auxiliary item for definitively enhancing the equipment item by reflecting a result of enhancing the equipment item.
